(19) United States
(12) Patent Application Publication
(10) Pub. No.: US 2007/0097964 A1
(43) Pub. Date: May 3, 2007

(54) Communication device and communication system

(76) Inventor: Shinichi Kashimoto, Ome-shi (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/588,062

(22) Filed: Oct. 25, 2006

(30) Foreign Application Priority Data
Nov. 1, 2005 (JP) 2005-318505

(51) Int. Cl. H04L 12/66

(52) U.S. Cl. 370/352; 370/401

(57) ABSTRACT

According to one embodiment, a communication apparatus includes specifying section which specifies sound devices/camera devices connected to a body, reading out section which reads out voice parameters/video parameters when the voice parameter/video parameter corresponding to the specified sound devices/camera devices are stored in the voice parameter storage/the video parameter storage, saving section which saves the voice parameters/video parameters decided in response to executions of voice/video communications in a voice parameter storage/a video parameter storage when the voice parameters/video parameters corresponding to the specified sound devices/camera devices are not stored in the voice parameter storage/the video parameter storage, and adjusting section which adjusts reception setting increased/decreased by the communication software and transmission setting increased/decreased by the communication software when the read out reception volume setting and the transmission volume setting are different from the reception volume setting and the transmission volume setting stored in a transmission/reception volume setting storage.

### CROSS-REFERENCE TO RELATED APPLICATIONS

This application is based upon and claims the benefit of priority from Japanese Patent Application No. 2005-318505, filed Nov. 1, 2005, the entire contents of which are incorporated herein by reference.

### BACKGROUND

1. Field

One embodiment of the invention relates to a communication device and a communication system performing voice/video communications via an Internet protocol (IP) network.

2. Description of the Related Art

A personal computer (PC)/system performing the voice/video communications on an IP has prevailed and a headset, a USB handset, a Bluetooth (registered trademark) headset, etc., to be a user interface of voice communications have been enriched. A proposal to “switch a hands-free telephone conversation to/from a handset telephone conversation in use of an information terminal” is disclosed in Jpn. Pat. Appln. KOKAI Publication 2004-320457. However, since these various sound devices defer in characteristics of audio and device drivers, if the sound device used by a user is switched, it is needed for achieving optimum voice communication setting to optimally change a voice parameter [voice volume, coder/decoder (hereinafter referred to as codec), voice frame length, the number of packets retaining in device driver, etc.]. As to a camera for video communications, along with enrichment of a USB camera, an IEEE 1394 camera, etc., connecting a plurality of cameras is a possible approach; however each camera differs in characteristic/performance, and if the user switches the camera to be used, it is needed for achieving optimum video communication setting to optimally change a video parameter (image size, frame rate, codec, etc.).

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary view showing a schematic configuration of a business telephone system regarding an embodiment of the present invention;

FIG. 2 is an exemplary block diagram showing a configuration of video telephone software (communication software) on a computer;

FIG. 3 is an exemplary view showing a voice parameter for each voice device;

FIG. 4 is an exemplary view showing a video parameter for each camera device;

FIG. 5 is an exemplary view showing a list of connection allowable devices;

FIG. 6 is an exemplary block diagram showing a configuration for performing device specifying, device authentication, and parameter storing/reading/updating on a computer;

FIG. 7 is an exemplary view showing configurations of a computer and a server for performing device specifying, device authentication, and parameter storing/reading/updating via a network; and

FIG. 8 is an exemplary flowchart showing a procedure of processing for performing device specifying, device authentication, and parameter storing/reading/updating.

### DETAILED DESCRIPTION

Various embodiments according to the invention will be described hereinafter with reference to the accompanying drawings. In general, according to one embodiment of the invention, a communication apparatus which executes voice/video communications via an Internet protocol network, comprises a body which being to be connected to a plurality of sound devices/camera devices, transmission/reception volume setting storage which stores reception volume and transmission volume, communication software executed by the body, specifying section which specifies the connected sound devices/camera devices by device names and addresses, voice parameter storage which stores voice parameters corresponding to the plurality of the sound devices, the voice parameters having reception volume, transmission volume, and reception setting increased/decreased by the communication software, and transmission setting increased/decreased by the communication software, video parameter storage which stores video parameters corresponding to the plurality of the camera devices, reading out section which reads out voice parameters/video parameters when the voice parameter/video parameter corresponding to the specified sound devices/camera devices are stored in the voice parameter storage/the video parameter storage, saving section which saves the voice parameters/video parameters decided in response to executions of voice/video communications in the voice parameter storage/the video parameter storage when the voice parameters/video parameters corresponding to the specified sound devices/camera devices are not stored in the voice parameter storage/the video parameter storage, and adjusting section which adjusts reception setting increased/decreased by the communication software and transmission setting increased/decreased by the communication software when the read out reception volume setting and the transmission volume setting are different from the reception volume setting and the transmission volume setting stored in the transmission/reception volume setting section.

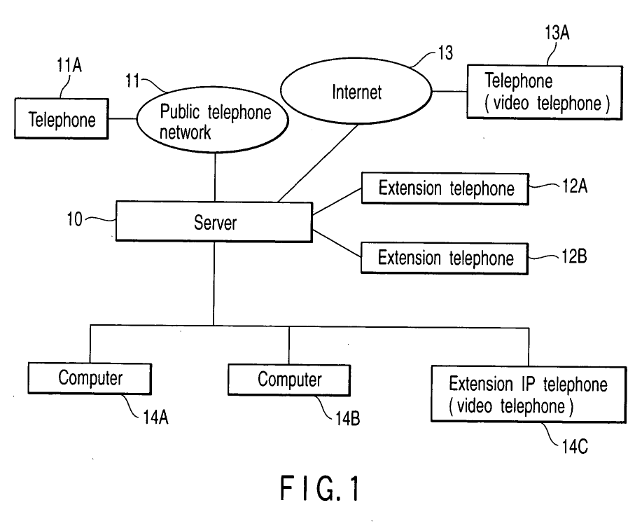

Explanations will be made by taking an example which follows. In the example, an IP communication device is configured by operating IP communication software (video telephone software) on a computer. A server 10, as shown in FIG. 1, can house a public telephone network 11 and extension telephones 12A and 12B with a fixed telephone set 11A connected thereto, and also can connect to an Internet protocol network (hereinafter referred to as the Internet) 13, connect to a telephone (video telephone) 13A on the Internet 13, and connect to computers 14A and 14B, and an extension IP telephone (video telephone) 14C with IP communication software on a LAN 14 through an IP operated thereon.

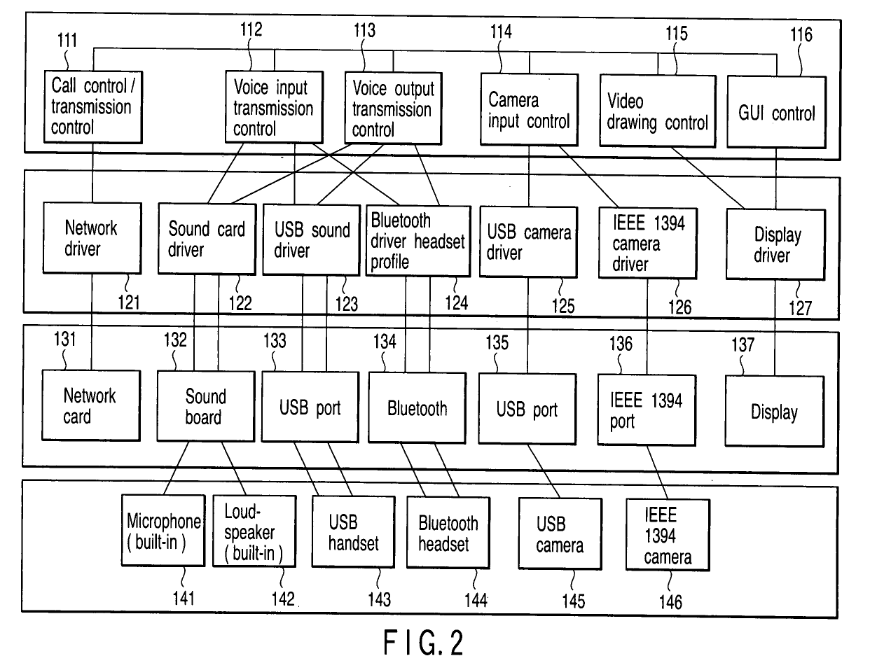

A configuration of video telephone software on a PC, which is an example of an embodiment of the present invention, will be shown in FIG. 2. Video telephone software 100 for a business telephone system consists of call control/transmission control 111, voice input control 112, voice output control 113, camera input control 114, video drawing control 115 and graphic user interface (GUI) control 116.

The call control/transmission control 111 conducts connection control to video telephone software on an opponent party computer via a server 10 connected to a network through a network card 131. A network driver 121 is a driver interfacing between the call control/transmission control 111 and the network card 131.

The call control/transmission control 111 notifies codec used by itself and a voice frame length (length of voice packet. 20 msec means a transmission of a pack of voice becoming time length of 20 msec in reproducing as a packet) to an opponent party.

Regarding to a video, the call control/transmission control 111 notifies also an image size and a frame rate (the number of frames per one second) to the opponent party.

When a call is connected, the call control/transmission control 111 starts voice input control and voice output control while taking the number of packets retaining in a sound volume and a device driver into account [because sound break in reproduction is generated due to running out of packets in the device driver, it is needed to retain packets (pockets which have been transferred to device driver, but have not been reproduced by device driver deferred to as remaining packets) in the device driver; however, the number of retaining packets becomes too large results in a delay]. With taking the image size and the frame rate into account, the call control/transmission control 111 conducts camera input control and video drawing control. The GUI control 116 controls keys of a software phone, blinking an LED, character display on a LCD, etc.

On a lower stage of the voice input control 112 and the voice output control 113, there are drivers such as a sound card driver 122, a USB sound driver 123, a Bluetooth driver, a headset profile (profile necessary to house Bluetooth headset) 124.

A sound card 132, a USB port 133, and a Bluetooth 134 are connected to the computer. A microphone 141 and a loud-speaker 142 are connected to the sound card 132. A Bluetooth headset 143 is connected to the Bluetooth 134.

On a lower state of the camera input control 114, a USB camera driver 125, and an IEEE 1394 camera driver 126 is provided. The USB camera driver 125 conducts input control of a USB camera 144 connected to a USB port 135. An IEEE 1394 camera driver 126 conducts input control of an IEEE 1394 camera 145 connected to the IEEE 1394 port 136.

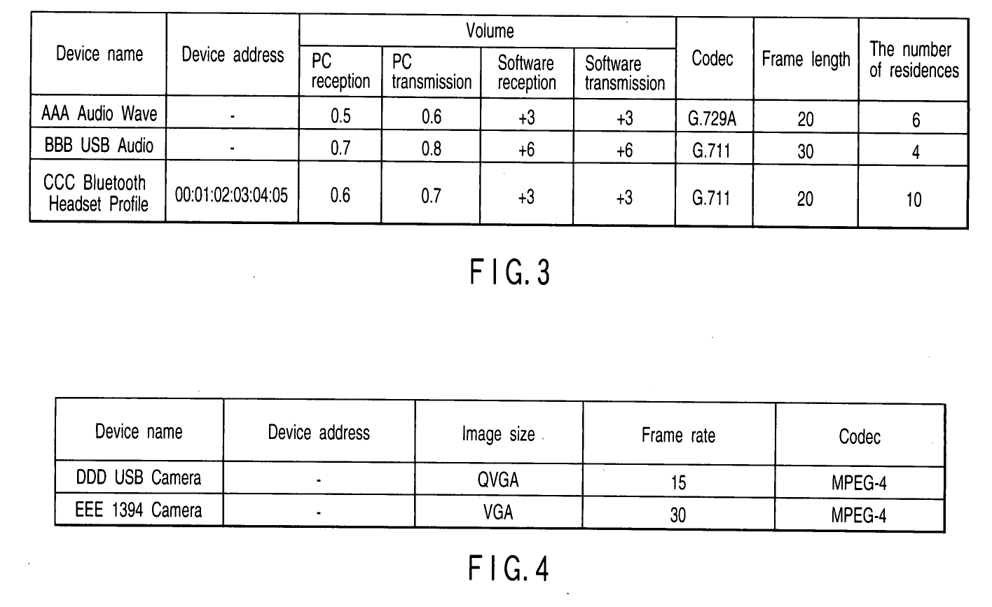

FIG. 3 shows voice parameters for each sound device. FIG. 3 shows each parameter that is a sound volume, a codec, a frame length and the number of packets to be retained in a device driver for each device name and device address of the sound device (such unique addresses are assigned to Bluetooth).

As for the voice volume, a value of a voice volume of a computer itself and a value increasing/decreasing only a voice volume relating to the IP communication by the video telephone software on the computer are set, and a reception volume and a transmission volume are set. That is, four items of a reception/transmission of a PC itself and a reception/transmission to be increased/decreased through the video telephone software are prepared. The reception/transmission of the PC itself is indicated by a ratio when a maximum voice volume is set to one, and the reception/transmission to be increased/decreased through the video telephone software are indicated in decibels (dBs) by putting “+” for addition and “−” for subtraction, respectively.

As described above, the reason to distinguish the voice volume of the computer itself from the value possible to be increased/decreased by means of the video telephone software is that the reception volume (loud-speaker volume)/transmission volume (microphone volume) of the computer have possibilities to be varied by the setting of the computer, so that if current values of those volumes are different from read out values, the value to be increased/decreased is adjusted though the video telephone software to make the final voice volumes level same as stored values.

FIG. 4 shows the video parameters for each camera device. Each of the parameters that are the picture size, frame rate (the number of frames per one second) codecs are indicated for each device name of the camera device.

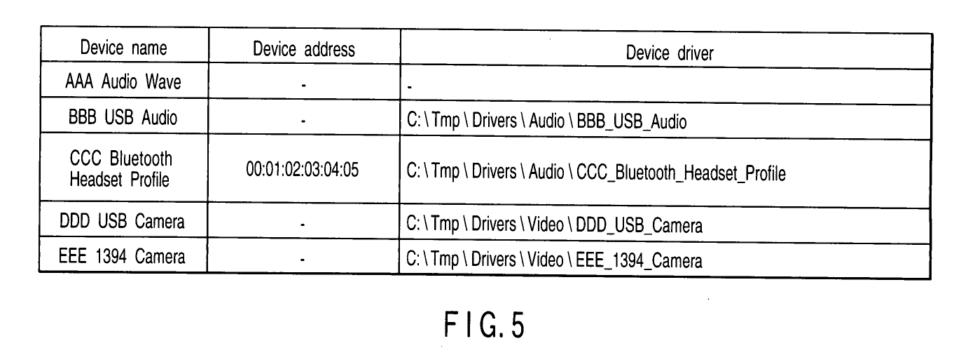

FIG. 5 shows the list of the devices allowed to be connected (hereinafter referred to as connection allowable device list). The list stores device names of the sound devices/camera devices to be allowed their connections and the device drivers [driver corresponding to profile in the case of device defied profile (profile to which communication function to be provided is defined)]. When the sound device/camera devices are connected, the communication device authenticates on the basis of the connection allowable device list and installs the device drivers only when the devices are authenticated.

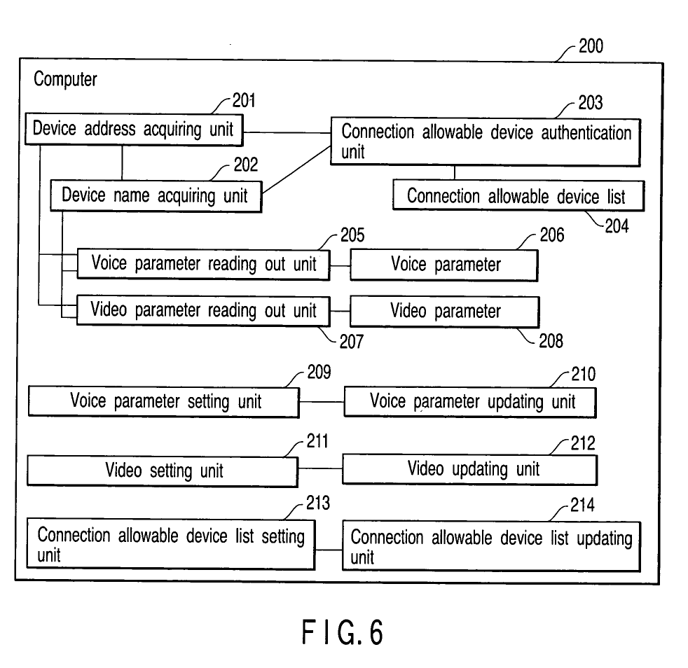

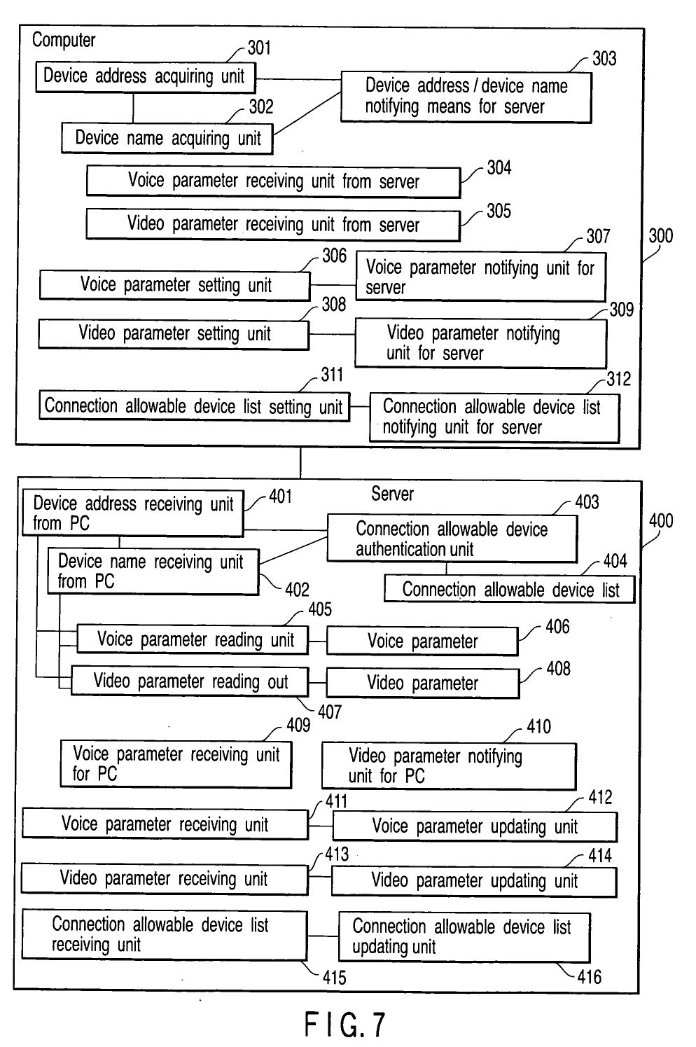

FIG. 6 shows a configuration of a computer to perform locally specifying devices, authenticating devices, and storing/reading/updating parameters, and FIG. 7 shows a configuration of a configuration on a PC and a configuration on a server to perform specifying the devices, authenticating the devices, and storing/reading/updating the parameters.

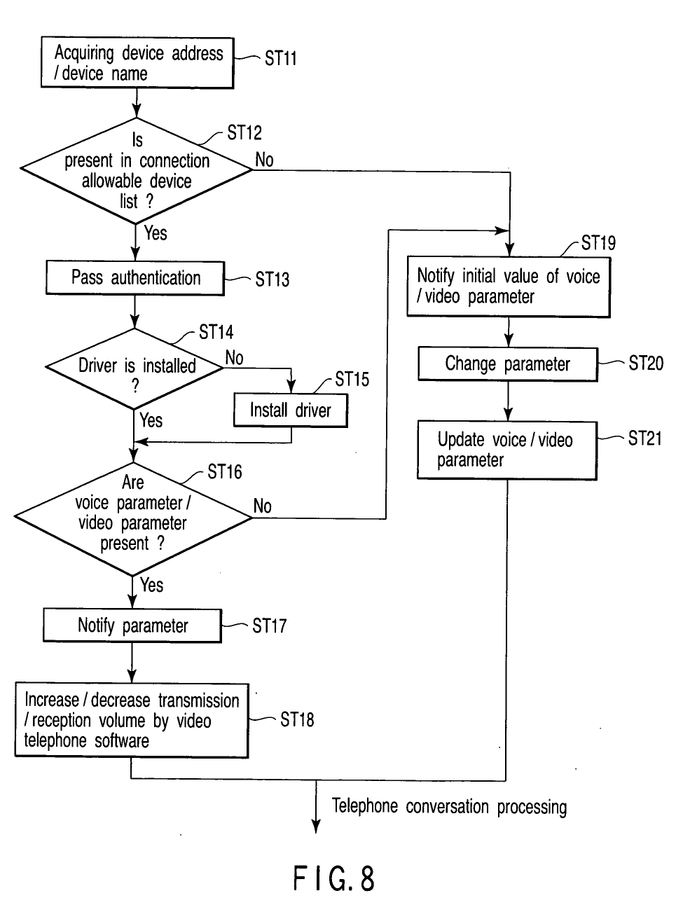

Hereinafter, operations of an embodiment of the present invention will be described with reference to FIG. 6 while referring to the flowchart in FIG. 8.

When the sound device/camera devices are connected to the computer, the video telephone software acquires the device addresses of the sound devices/camera devices through a device address acquiring unit 201. And/or the video telephone software obtains the device names by means of a device name acquiring unit 202 (step ST11). If a connection allowable device list 204 in FIG. 5 is not stored, a connection allowable device authentication unit 203 allows connections of all the devices. If the device list 204 is stored, the device authentication unit 203 determines whether the obtained device addresses/device names are present in the device list 204 (step ST12). If they are present in the device list 204 (Yes, in Step ST12), the device authentication unit 203 authenticates them (step ST13). Next, the device authentication unit 203 determines whether or not the corresponding driver has been installed in a computer 200 (step ST14). If the driver has not been installed (No, in step ST14), the device authentication unit 203 installs the driver in the computer 200 (step ST15).

Next to this, the device authentication unit 203 determines whether voice parameters/video parameters corresponding to the connected device addresses/device names are stored in a voice parameter 206 shown in FIG. 3 and a video parameter 208 shown in FIG. 4 (step ST16).

If the voice parameters/video parameters corresponding to the device addresses/device names are stored (Yes, in step ST16), a voice parameter reading out unit 205/video parameter reading out unit 207 notifies voice/video codecs, voice frame lengths, image sizes and video frame rates used by itself to the call control/transmission control unit 111 (step ST17). When performing connection control with the opponent party, the call control/transmission control 111 notifies the voice/video parameters 206, 208.

As to the voice volume among the voice parameter 206, the four items of reception/transmission of the PC itself, and reception/transmission increasing/decreasing through the video telephone software are set as shown in FIG. 3. For instance, if the device name of a sound device to be used is “BBB USB Audio” and the current value of a reception voice volume (loud-speaker volume) of the computer itself is “0.9”, and the current value of a transmission voice volume (microphone voice volume) is “1.0”, these values are different form the read out values of the reception volume and the transmission volume of the computer itself (“0.7”, and “0.8” each) (this occurs when user changes the volume setting of the computer for the purpose having no relation to the video telephone software). In this case, although the read out values of the values to be increased/decreased by the video telephone software in both reception/transmission have been +6 dB, the communication system changes each of these values into, for instance, +3 dB by the increased amounts of the reception/transmission volumes of the PC itself so as to make the final volumes level equal to the stored values (step ST18). Wherein, the volume parameters of the four items can be stored by updating the values in FIG. 3.

After the call is connected, the communication system transfers the voice volume and the number of packets retaining in the device driver as initial values to the voice input control 112 and the voice output control 113, and transfers the picture sizes and the frame rates to the camera input control 114 as initial values. With using these values as the initial values, the communication system can reproduce optimum voice communication setting/video communication setting for each sound device/camera device.

In the processing of the step ST12, if the connection allowable device list 204 is not present, if the voice parameter 206 and the video parameter 208 are not stored, or if the voice parameter/video parameter corresponding to the device addresses/device names are not stored (No, in step ST16), a voice parameter reading out unit 205/a video reading out unit 207 notify the specified values of the voice/video parameters (constant regardless of device) as the initial values to the call control/transmission control 111 (step ST19).

In the voice/video communications after this procedure, the user changes these parameters by using a voice parameter setting unit 209/video parameter setting unit 211 (step ST20). The changed parameters update the voice parameter 206 and the video parameter 208 by means of a voice parameter setting unit 210/video parameter updating unit 212 (step ST21). And when the user does not perform voice/video communication, etc., if the user changes the connection allowable device list 204 by using a connection allowable device list setting unit 213, a connection allowable device list updating unit 214 updates the connection allowable device list 204.

When reproducing the optimum voice communication setting/video communication setting for each sound device/camera device like the manner given above, the communication system can make voice communications among a plurality of sound devices connected to one set of the IP communication device and one or more opponent party communication devices by simultaneously inputting/outputting voices to the connected plurality of sound devices after starting voice communications. And further, the communication system can also make video communications among a plurality of cameras connected to this communication device and to a display of one set of the IP communication device and one or more opponent party communication devices by simultaneously performing camera inputs from the connected plurality of camera devices to display video from one or more opponent parties.

Next, an example of an establishment system in the case in which the video telephone software on the PC with the devices connected thereto does not perform “specifying connected device”, “storing/reading/updating voice parameter/video parameter” and “authenticating device”, but the server on the communication system including this PC performs aforementioned communication system.

When the sound devices/camera devices are connected to a computer 300, the video telephone software on the PC obtains the device addresses/device names by means of a device address acquiring unit 301/device name acquiring unit 302 on the computer side to notify them to a server 400 by using a device address/device name notifying unit 303 therefor. The sever 400 receives them by using a device address receiving unit 401/device name receiving unit 402 from the PC. When the connection allowable device list 404 in FIG. 5 is stored in the server 400 (if connection allowable device list 404 show in FIG. 5 is not stored, connections of all devices are allowable), a connection allowable device authentication unit 403 checks whether the devices are present in the connection allowable device list 404 or not through the device addresses/device names. If the devices are present in the connection allowable device list 404, the connection allowable device authentication unit 403 authenticates the connections of the devices. The device authentication unit 403 inquires to the computer 300 if the relevant device drivers are installed, and if they are not installed, it instructs the computer 300 to install the device drivers.

Sequentially, when the voice parameters 406 shown in FIG. 3 and the video parameter 408 shown in FIG. 4 are stored in the server 400, and the voice parameters/video parameters corresponding to the device addresses/device names are stored therein, the server 400 notifies the voice parameters and video parameters to the computer 200 by using a voice parameter notifying unit 409/video parameter notifying unit 410 for the PC. The computer 200 receives the voice parameters and video parameters from the server 400 by using the voice parameter receiving unit 304/video receiving unit 305 from the server 400 to transfer the voice/video codecs, voice frame lengths, image sizes and video frame rates used from itself to the call control/transmission control 111. These parameters are notified to the opponent party in performing the connection control with the opponent party. As to the voice volume among the voice parameters, as shown in FIG. 3, the communication system prepares four items that are the reception/transmission of the computer itself and the reception/transmission increased/decreased through the video telephone software. For instance, if the device name of the sound device to be used is BBB USB Audio, and if the current value of the reception volume (loud-speaker volume) of the PC itself is “0.9” and the current value of the transmission volume (microphone volume) of the PC itself is “1.0”, these values are different from the read out values (“0.7” and “0.8” each) of the reception volume and transmission volume of the PC itself (this situation is generated when the user changes the volume setting of the PC for the purpose not relating to the video telephone software after storing these values). In such a case, although the read out values of the values increasing/decreasing by the video telephone software are +6 dB for both the reception/transmission, the system changes both the values to, for instance, +3 dB by the increased volumes of the reception/transmission volume of the PC itself to make the final volume levels equal to the stored values (wherein the changed voice parameters of the four items are stored by updating the list shown in FIG. 2). When the call is connected, the communication system transfers the voice volume and the number of packets retaining in the device driver to the voice input control 112 and voice output control 113 as the initial values and transfers the image size and the frame rates to the camera input control 114 as initial values. With using these values as the initial values, the communication system can reproduce optimum voice communication setting/video communication setting for each sound device/camera device.

If the voice parameter 406/video parameter 408 are not stored in the server 400, or if the voice parameter 406/video parameter 408 corresponding to the device address/device name are not stored therein, the server 400 notifies the specified values (constant regardless of device) of the voice parameter/video parameter to the computer 300 by using the voice parameter notifying unit 409/video parameter notifying unit 410 for the PC. The computer 300 receives them from the server 400 by using the voice parameter receiving unit 304/video parameter receiving unit 305 to transfer the specified values (constant regardless of device) of the voice parameter/video parameter to the call control/transmission control 111, as the initial values.

In the voice/video communications after this, when the user changes the parameters by means of the voice parameter setting unit 306/video parameter setting unit 308, the communication system notifies the changed parameters to the server 400 by using a voice parameter notifying unit 307/video parameter notifying unit 309 for the server 400. The server 400 receives new voice parameters/video parameters by use of a voice parameter receiving unit 411/a video parameter receiving unit 413. A voice parameter updating unit 412/a video parameter updating unit 414 updates the voice parameter 406 and the video parameter 408. When the user does not perform video/video communication, if the user changes the connection allowable device list 404 by using the connection allowable device list setting unit 311, the communication system notifies the fact to the server 400 by using the connection allowable device list notifying unit 312 for the server 400. The server 400 receives the connection allowable device list 404 changed by a connection allowable device list updating unit 415. A connection allowable device list updating unit 416 updates the connecting allowable device list 404.

As mentioned above, when the communication system does not perform “specifying connected device”, “storing/reading/updating voice parameter/video parameter” and “authenticating device” through the video telephone software on the PC with the device connected thereto, but even when the server of the communication system including the PC performs the foregoing processing, the communication system reproduces the optimum voice communication setting/video communication setting for each sound device/camera device. And further, simultaneously inputs/outputs voices to the connected plurality of sound devices after starting the voice communications, then, the communication system performs the voice communications among the polarity of sound devices connected to the one set of the IP communication device and one or more opponent party communication devices. Further, the communication system can perform video communications among the plurality of cameras connected to the IP communication device the display of the one set of the IP communication device and this communication device and one or more opponent parties by simultaneously processing the camera inputs from the connected plurality of camera devices to display the video s from one or more opponent parties after starting the video communications.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A communication device which executes voice/video communications via an Internet protocol network, comprising:
a body which being to be connected to a plurality of sound devices/camera devices;
a transmission/reception volume setting storage which stores reception volume and transmission volume;
a communication software executed by the body;
a specifying section which specifies the connected sound devices/camera devices by device names and addresses;
a voice parameter storage which stores voice parameters corresponding to the plurality of the sound devices, the voice parameters having reception volume, transmission volume, and reception setting increased/decreased by the communication software, and transmission setting increased/decreased by the communication software;
a video parameter storage which stores video parameters corresponding to the plurality of the camera devices;
a reading out section which reads out voice parameters/video parameters when the voice parameter/video parameter corresponding to the specified sound devices/camera devices are stored in the voice parameter storage/the video parameter storage;
a saving section which saves the voice parameters/video parameters decided in response to executions of voice/video communications in the voice parameter storage/the video parameter storage when the voice parameters/video parameters corresponding to the specified sound devices/camera devices are not stored in the voice parameter storage/the video parameter storage; and
a adjusting section which adjusts reception setting increased/decreased by the communication software and transmission setting increased/decreased by the communication software when the read out reception volume setting and the transmission volume setting are different from the reception volume setting and the transmission volume setting stored in the transmission/reception volume setting section.

2. The communication device according to claim 1, further comprising:
a list of device names and device addresses of connection allowable sound devices/camera devices; and
a driver storage which stores drivers of connection allowable devices stored therein, wherein
the communication device installs the drivers stored in the driver storage if the sound devices/camera devices which have passed authentication by authenticating on the basis of the list, when an allowable driver cannot be used for the body after the sound device/camera devices are connected.

3. The communication device according to claim 1, further comprising initial values of voice parameters and video parameters used when voice parameters/video parameters corresponding to the specified sound devices/camera devices are not stored in the voice parameter storage/the video parameter storage, wherein
the voice parameters/video parameters decided in response to executions of the voice/video communications are decided by changing initial values of the voice parameters and the video parameters.

4. The communication device according to claim 1, making voice communications among a plurality of sound devices connected to one set of the body and one or more opponent party communication devices by simultaneously inputting/outputting voices to the connected plurality of the sound devices after starting the voice communications; and making video communications among a plurality of cameras connected to a display of one set of Internet protocol (IP) communication device and of the IP communication device and one or more opponent communication devices by simultaneously processing camera inputs from the connected plurality of camera devices to display videos from one or more opponent parties after starting the video communications.

5. A communication system executing voice/video communications via an IP network, comprising:
a communication device including a body to which a plurality of sound devices/camera devices are connectable, transmission/reception volume setting section with reception volume of the body and transmission volume of the body stored therein, and communication software executed by the body; and
a server including specifying section which specifies the sound devices/camera devices, connected to the body, through device names and addresses, storing voice parameter which stores voice parameter corresponding to the plurality of the sound devices, the voice parameters having reception volume of the main body, transmission volume of the main body, reception setting increased/decreased by the communication software, and transmission setting increased/decreased by the communication software, video parameter storage which stores video parameters corresponding to the plurality of the camera devices, reading section which reads out voice parameters/moving picture parameters when the voice parameters/moving picture parameters corresponding to the specified sound devices/camera devices are stored in the voice parameter storage/the video parameter storage, and saving section which saves the voice parameters/video parameters decided as s result of executions of voice/video communications when the voice parameters/moving picture parameters corresponding to the specified sound devices/camera devices are not stored in the voice parameter storage/the video parameter storage.

6. The communication system according to claim 5, wherein
the server further comprises driver storage section which stores a list of device names and addresses of connection allowable sound devices/camera devices, and drivers of connection allowable devices, and
installs the drivers stored in the driver storage section when sound devices/camera devices have passed authentication by authenticating on the basis of the allowance list and if any allowable driver cannot be used for the body, after the sound devices/camera devices are connected to the body.

7. A communication method of a communication device which comprises a body executing voice/video communications via an Internet protocol network and possible to connect a plurality of sound devices/camera devices, and communication software executed by the body, the communication method comprising:
specifying sound devices/camera devices connected to the body by device names and addresses;
reading out the voice parameters/video parameters when voice parameters/video parameters corresponding to the specified sound devices/camera devices are stored in a voice parameter storage which stores voice parameters corresponding to the plurality of the sound devices, the voice parameters having reception volume, transmission volume, and reception setting increased/decreased by the communication software, and transmission setting increased/decreased by the communication software, and a video parameter storage which stores video parameters corresponding to the plurality of the camera devices;
storing voice parameters/video parameters decided in response to executions of voice/video communications when the voice parameters/video parameters corresponding to the specified sound devices/camera devices are not stored in the voice parameter storage/the video parameter storage; and
adjusting reception setting increased/decreased by the communication software and transmission setting increased/decreased by the communication software when the read out reception volume setting and the transmission volume setting are different from the reception volume setting and the transmission volume setting stored in the transmission/reception volume setting storage.

8. The communication method according to claim 7, wherein the communication device further comprises driver storage means with a list of device names and addresses of connection allowable sound devices/camera devices and drivers of connection allowable devices stored therein, and
the communication device performs authentication on the basis of the list when the sound devices/camera devices are connected to the body; and installs the drivers stored in the driver storage means into the body when the sound devices/camera devices have passed the authentication and an allowable driver cannot be used for the body.

9. The communication method according to claim 7, wherein the communication device further comprises initial values of voice parameters and video parameters used when voice parameters/video parameters corresponding to the specified sound devices/camera devices are not stored in the voice parameter storage/the video parameter storage, and
the voice parameters/video parameters decided in response to executions of the voice/video communications are decided by changing initial values of the voice parameters and the video parameters.
